(19) United States
(12) Patent Application Publication
(10) Pub. No.: US 2017/0357783 A1
(43) Pub. Date: Dec. 14, 2017

(54) METHOD AND SYSTEM FOR LICENSE MANAGEMENT OF NETWORK ELEMENTS

(71) Applicant: Arista Networks, Inc., Santa Clara, CA (US)

(72) Inventors: Ethan Barnett Rahn, Los Angles, CA (US); Nathan Boyd Kitchen, San Francisco, CA (US); Sonu Kumar Giri, Bangalore (IN); Karan Jayesh Bavishi, Bangalore (IN); Anoop Dawani, Bangalore (IN)

(73) Assignee: Arista Networks, Inc., Santa Clara, CA (US)

(21) Appl. No.: 15/448,377

(22) Filed: Mar. 2, 2017

(30) Foreign Application Priority Data
Jun. 14, 2016 (IN) 201641020269

(51) Int. Cl. G06F 21/10

(52) U.S. Cl. CPC G06F 21/105; G06Q 2220/18

(57) ABSTRACT

A method for license management. The method includes receiving a first license request for a feature from a network element and in response to the first license request, making a first determination that no feature licenses of a first type are available for the feature. The method further includes based on the first determination, making a second determination that a feature license of a second type is available for the feature, and providing the feature license of the second type to the network element.

### CROSS-REFERENCE TO RELATED APPLICATIONS

This non-provisional patent application claims priority to Indian Patent Application No. 201641020269, filed on Jun. 14, 2016 in the Indian Intellectual Property Office, under 35 U.S.C. §119(a). Indian Patent Application No. 201641020269 is incorporated herein by reference in its entirety.

### BACKGROUND

Users of a software and/or hardware features may be required to purchase a license in order to activate the software and/or hardware features. License management may be used to enforce proper licensing.

### SUMMARY

In general, in one aspect, the invention relates to a method for license management. The method includes receiving a first license request for a feature from a network element and in response to the first license request, making a first determination that no feature licenses of a first type are available for the feature. The method further includes based on the first determination, making a second determination that a feature license of a second type is available for the feature, and providing the feature license of the second type to the network element.

In general, in one aspect, the invention relates to a method for license management. The method includes sending, from a network element, a first license request for a first feature to a license server, receiving, in response the first license request, a first feature license of a first license type, activating the first feature on the network element using the first feature license of the first license type, in response to activating the first feature on the network element, collecting feature usage data for the first feature, providing the feature usage data to the license server, sending a second license request for a second feature to the license server, receiving, in response the second license request, a second feature license of a second license type, in response to receiving the second feature license of the second license type: periodically sending license requests to the license server to obtain one selected from a group consisting of a third feature license of the first license type and a fourth feature license of a third license type wherein the second feature is not activated in response to receiving the second feature license of the second license type.

In general, in one aspect, the invention relates to a method for license management. The method includes receiving feature usage data associated with a plurality of network elements using a feature, determining, using the feature usage data, a feature license type distribution for the feature, generating, based on the feature license type distribution, a feature license set comprising a plurality of feature licenses, wherein the feature license set comprises at least one feature license of a first license type and at least one feature license of a second license type, and providing the feature license set to a local license server.

In general, in one aspect, the invention relates to a system for license management. The system includes a coordination point operatively connected to plurality of network elements, wherein the coordination point is configured to: receive a license request for a feature from a network element of the plurality of network elements, in response to the license request: make a first determination that no feature licenses of a first type are available for the feature, based on the first determination, make a second determination that a feature license of a second type is available for the feature, and provide the feature license of the second type to the network element, after providing the feature license of the second license type to the first network element: receive, from the first network element, feature usage data for the feature, and provide the feature usage data to a central licensing manager.

### BRIEF DESCRIPTION OF DRAWINGS

FIG. 1 shows a system in accordance with one or more embodiments of the invention.

FIGS. 2A-2B show the relationship between various components in the system in accordance with one or more embodiments of the invention.

FIGS. 3-5 show flowcharts in accordance with one or more embodiments of the invention.

FIG. 6 shows a computing system in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

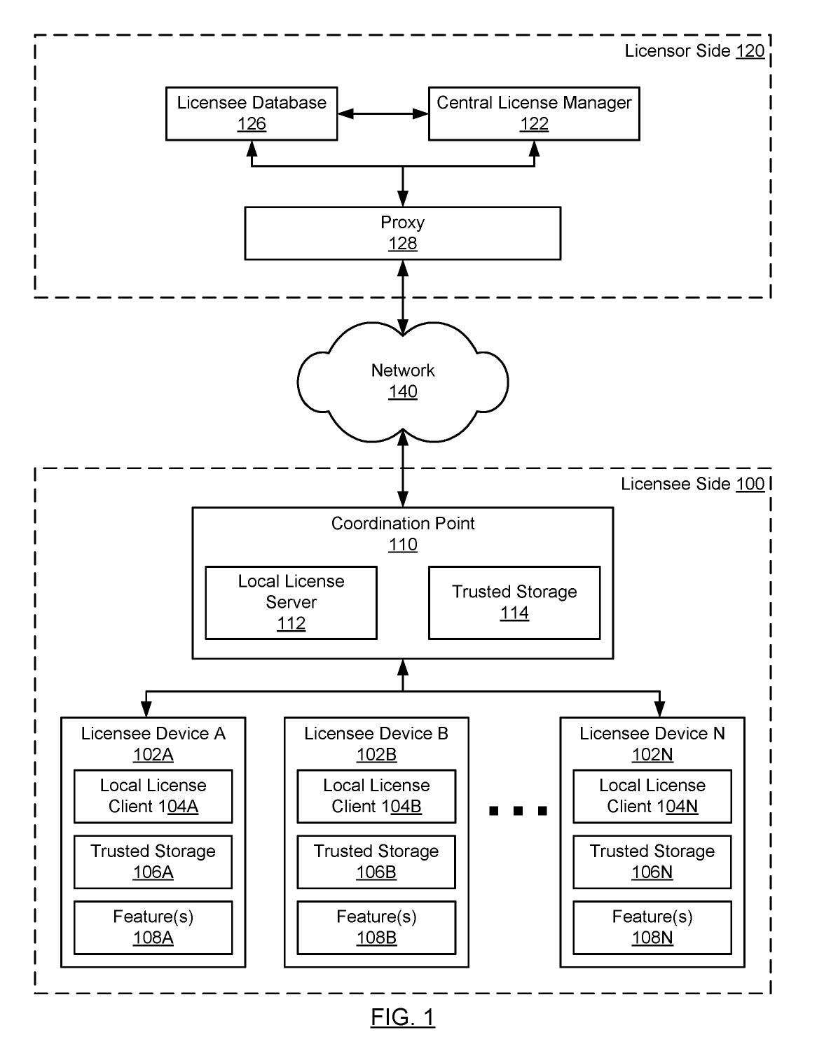

In the following description of FIGS. 1-6, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for license management. More specifically, embodiments of the invention relate to provisioning feature license sets, which include different types of licenses for the same feature. The license types include, e.g., standard, overdraft, and disable. Each type of license, when activated on a network element, initiates a different set of actions. The actions may include, but are not limited to, (i) activating the feature, (ii) activating the feature, initiating the gathering of feature usage data, and providing the feature usage data to the central license manager, and (iii) not activating the feature and periodically attempting to obtain an overdraft or standard license.

In accordance with one or more embodiments of the invention, the use of different types of licenses for the same feature may provide more predictable and less disruptive operation for network elements. More specifically, by providing different types of licenses, embodiments of the invention may enable a network element to activate a given feature even when there are no more standard licenses available. In this scenario, by using an overdraft license, the network element's performance and/or usage is not immediately impacted. This enables the network administrator to reactively purchase standard licenses without the operation of the network elements being impacted.

FIG. 1 shows a system for license management. The system, in accordance with one or more embodiments of the invention, includes multiple components on a licensee side (100) and on a licensor side (120). The licensee side may be a legal entity, e.g., a corporation that licenses software and/or hardware. The licensor may be another legal entity, e.g., a corporation that provides the license for the software or hardware being licensed by the corporation on the licensee side (100). Further, additional parties may be involved. For example, the licensor may rely on third party software and/or hardware to administrate and enforce licensing.

The system, on the licensee side (100), in accordance with one or more embodiments of the invention, includes licensee devices (102A-102N), and one or more coordination points (110). The system, on the licensor side (120), in accordance with one or more embodiments of the invention, includes a central license manager (122) and a licensee database (126), and may further include a proxy (128). The components on the licensee side (100) and on the licensor side (120) may be operationally connected by a network (140), e.g., the Internet, a local area network or a dedicated connection. Each of the above components is further described below.

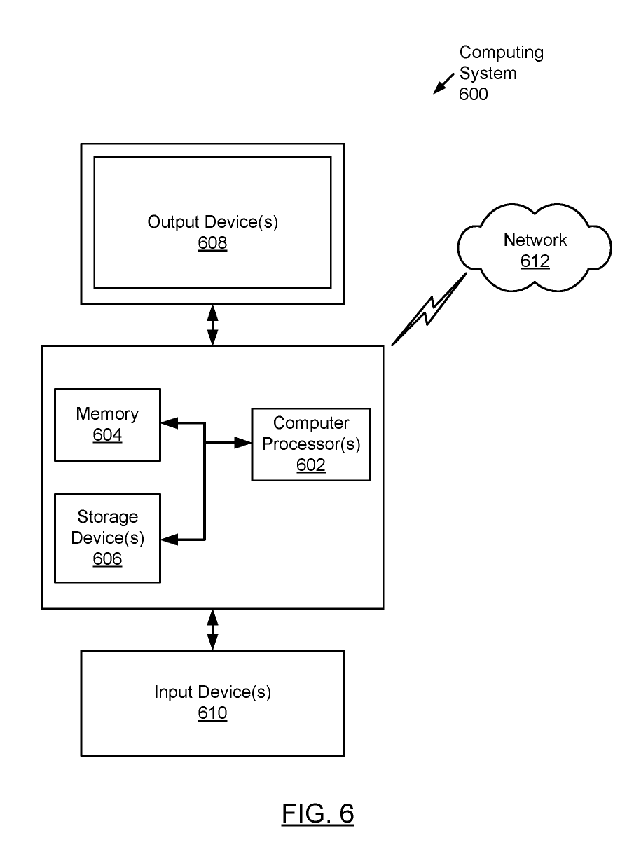

Turning to the licensee side (100), the licensee devices (102A-102N) may be computing devices (e.g., servers, desktop personal computers, laptop personal computers, tablet computers, etc.) such as the computing device described with reference to FIG. 6, network elements (e.g., routers, switches or multilayer switches) or any other types of devices that include one or more features (108A-108N) that require a license in order to be activated. A feature may be a hardware or software-based functionality. Any functionality or characteristic that requires a license in order to be activated may be a feature. For example, a feature in a network element may be an implementation of a particular network protocol (e.g., the border gateway protocol (BGP), a management interface, etc.) Those skilled in the art will appreciate that features (108A-108N) are not limited to the above examples.

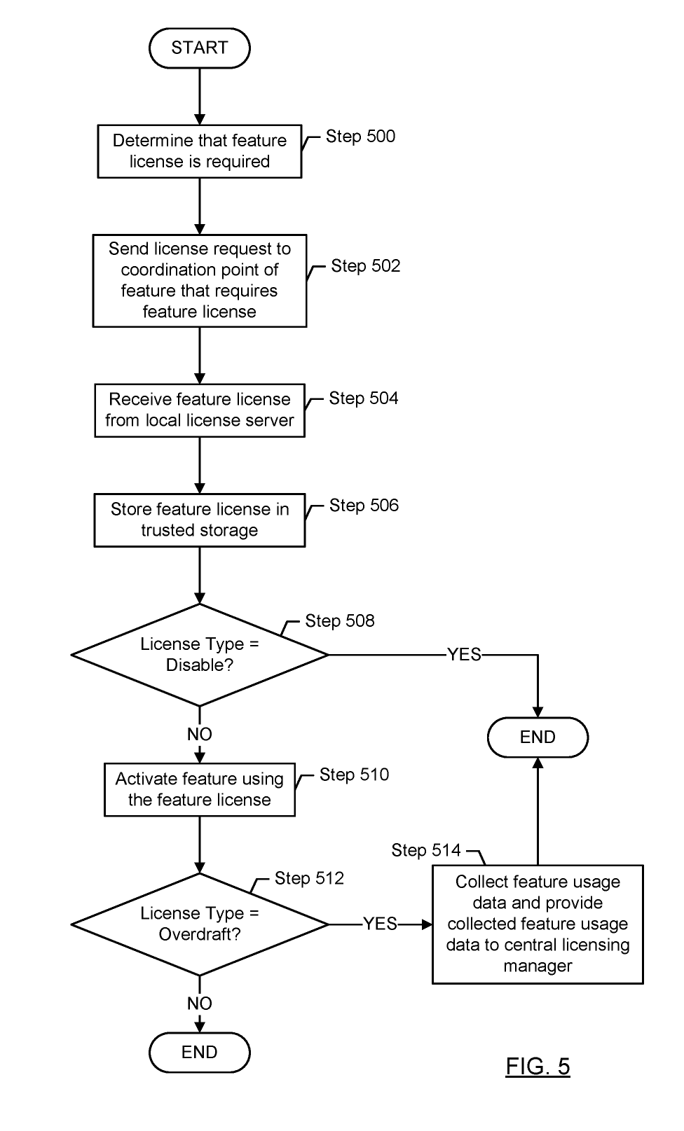

In one embodiment of the invention, each of the licensee devices (102A-102N) includes a local license client (104A-104N). A local license client on a licensee device may be responsible for obtaining one or more feature licenses for one or more features on the licensee device (see e.g., FIG. 5) and for enforcing license terms such as the beginning of the license term, the end of the license term and device-specific limitations such as the limited use of a feature license in a particular configuration, on a particular hardware, etc. Further, if a feature license has an expiration date, the local license client may also be responsible for the renewal of the license, prior to expiration of the feature license. See e.g., FIG. 5. The local license clients (104A-104N) may be custom software services developed by the licensor, or alternatively, elements of the local license clients or the entire local license clients may be software services provided by a third party.

In one embodiment of the invention, each of the licensee devices (102A-102N) further includes trusted storage (106A-106N). The trusted storage may store received feature licenses and may protect feature licenses against unauthorized access and unauthorized modification. In one embodiment of the invention, only the local license client (104A-104N) and/or other license monitoring and enforcing components have access to the trusted storage (106A-106N), thus giving them exclusive authority over management and use of the feature licenses. The trusted storage may include volatile and/or non-volatile memory such as, for example, random access memory (RAM), solid state memory and hard disk drives. The trusted storage may be encrypted to protect its content against unauthorized access. Further, content may be digitally signed to prevent tampering with the content.

The licensee devices (102A-102N), in accordance with an embodiment of the invention, are operatively connected to the coordination point (110). The licensee devices and the coordination point may communicate using any combination of wired and/or wireless communication protocols. The licensee devices and the coordination point may be connected via a local network (e.g., an Ethernet network) or via a wide area network (e.g., the Internet). The communication between the licensee devices and the coordination point may include any combination of secured (e.g., encrypted) and non-secured (e.g., un-encrypted) communication. The manner in which the licensee devices (102A-102N) and the coordination point (110) communicate may vary based on the implementation of the invention.

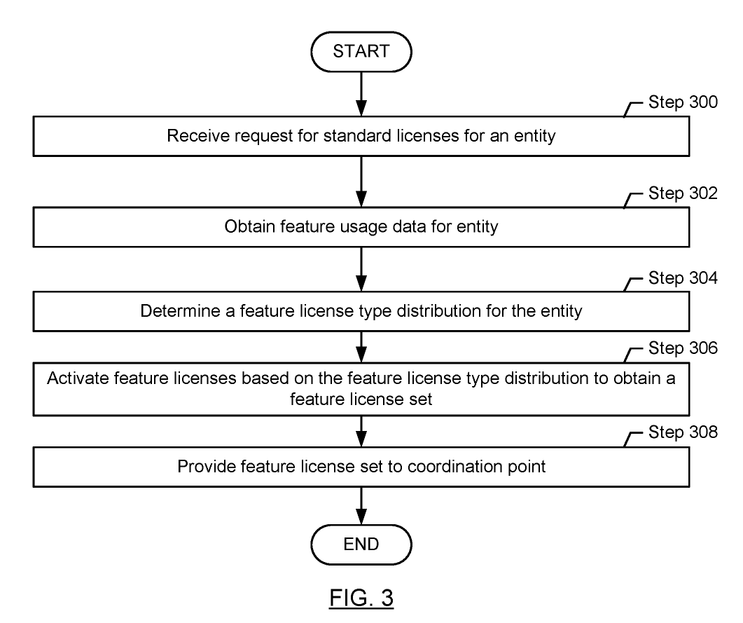

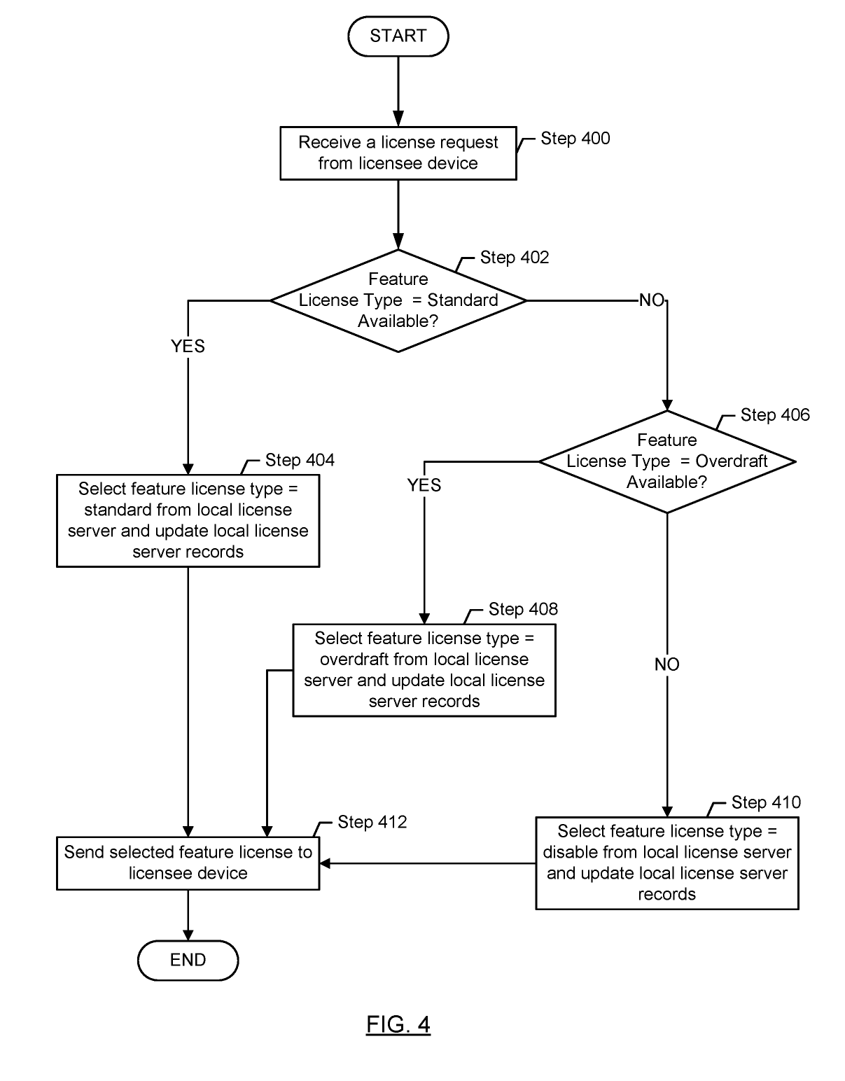

Continuing with the discussion of the components on the licensee side, the coordination point (110), in accordance with one or more embodiments of the invention, provides a mechanism to share information between and/or with the licensee devices (102A-102N). More specifically, the coordination point (110), in accordance with an embodiment of the invention, services license requests for feature licenses from licensee devices (see e.g., FIG. 4). The coordination point (110), in accordance with an embodiment of the invention, provides feature usage data to the licensor side (120) and obtains feature license sets (which include allocated feature licenses) from the licensor side (120) (see e.g., FIGS. 3-4).

The coordination point, in accordance with an embodiment of the invention, is a service that may execute on a dedicated or shared physical or virtual server. The coordination point may be hosted, for example, by a computing device similar to the one described in FIG. 6. Alternatively, the coordination point (110) may be hosted by one of the licensee devices (102A-102N). The coordination point may be hosted, for example, on a network router or switch. In one embodiment of the invention, multiple redundant coordination points (110) exist on the licensee side (100). One of the coordination points may be the active coordination point that performs one or more of the steps described below with reference to FIGS. 3-5, whereas the other coordination points may be backup coordination points that mirror the active coordination point, without actively contributing to the license service scheme described below. A backup coordination point may take over the role of the master coordination point if the master coordination point fails, thus providing continuous availability of the license services.

In one embodiment of the invention, the coordination point (110) includes a local license server (112). The local license server, in accordance with an embodiment of the invention, is configured to service license requests from the licensee devices and to obtain feature license sets from the licensor side (120). (See e.g., FIGS. 3-4). The local license server (112) may be a custom software service developed by the licensor, or alternatively, elements of the local license server or the entire local license server may be a software service provided by a third party.

In one embodiment of the invention, the coordination point further includes trusted storage (114). The trusted storage may store received feature licenses (which may be transmitted as part of a feature license set) and may protect feature licenses against unauthorized access. In one embodiment of the invention, only the local license server (112) has access to the trusted storage (114), thus giving the local license server the exclusive control over providing feature licenses to the local license clients (104A-104N). The trusted storage may include volatile and/or non-volatile memory such as, for example, random access memory (RAM), solid state memory and hard disk drives. The trusted storage may be encrypted to protect its content against unauthorized access. Further, content may be digitally signed to prevent tampering with the content.

Turning to the licensor side (120), the central license manager (122), in accordance with an embodiment of the invention, provides a portal for obtaining and managing licenses for the licensee. For example, the portal may include a web page that network administrators of the corporation on the licensee side (100) may access to view license usage statistics, to manage the binding of licenses and/or to purchase licenses for the licensee devices (102A-102B). The central license manager may administrate the purchased licenses (also referred to as standard licenses) and may release the licenses (including purchased licenses) for use on the licensee devices, as described below in FIGS. 3-5. The central license manager (122) may be a custom software service developed by the licensor, or alternatively, elements of the central license manager or the entire central license manager may be a software service provided by a third party. The central license server may be hosted on a dedicated or shared physical or virtual server, for example, on a computing device similar to the computing device described in FIG. 6. Further, the central license manager may be distributed over multiple servers, e.g., for load balancing and/or redundancy.

The system, on the licensor side, further includes a licensee database (126), in accordance with an embodiment of the invention. The licensee database may include credentials of licensees. The credentials may include, but are not limited to, customer IDs (e.g., a corporation's name, an administrator account name, or an arbitrarily selected string) and passwords. The central license manager (122) may refer to the licensee database (126) in order to validate requests from the coordination point (110) (e.g., request sent in accordance with FIG. 3) The central licensing manager may process the request only if the credentials provided along with the request match the credentials in the licensee database (126).

In one embodiment of the invention, the licensee database (126) is a lightweight directory access protocol (LDAP) server. Alternatively, any other type of database may be used to store licensee credentials. The licensee database may be, for example, a list, a spreadsheet or any other type of database suitable for storing credentials.

In one embodiment of the invention, the system, on the licensor side, further includes a proxy. The proxy (128), in accordance with an embodiment of the invention is a reverse proxy server that forwards requests, e.g., from the coordination point (110) to the central license manager (122). The proxy may be used, for example, for protocol translation, e.g. to secure communications from/to the local license server (104), to rewrite uniform resource locators (URLs), to compress/decompress data being sent/received, for load balancing and/or as a protection against distributed denial of service (DDoS) attacks.

The central license manager (122), the licensee database (126), and the proxy (128) may be connected via a local network (e.g., an Ethernet network) or via a wide area network (e.g., the Internet). The communication between the central license manager the licensee database, and the proxy may include any combination of secured (e.g., encrypted) and non-secured (e.g., un-encrypted) communication. The manner in which the central license manager, the licensee database, and the proxy communicate may vary based on the implementation of the invention. For example, all communications may be encrypted in scenarios in which one or more of the servers on the licensor side are cloud-based, whereas some communications may not be encrypted if the servers are located in an isolated, protected local area network.

One skilled in the art will recognize that the architecture of a system for license management is not limited to the components shown in FIG. 1. For example, the system may have any number of licensee devices. Further, multiple coordination points may exist to provide redundancy. In addition, some of the services shown as discrete components in FIG. 1 may be co-hosted on a single computing device. For example, the licensee database and/or the central license manager may be co-hosted. Similarly, the coordination point may be hosted by one of the licensee devices, without departing from the invention.

In one or more embodiments of the invention, sensitive data such as feature licenses, credentials, etc. may be exchanged between different services. To protect these data against unauthorized access, communications between the components of the system may rely on cryptographically secured protocols such as, for example, transport layer security (TLS) and secure sockets layer (SSL). Further to prevent tampering with exchanged data, the exchanged data may be cryptographically signed.

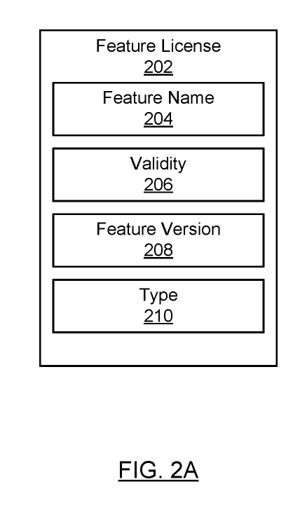

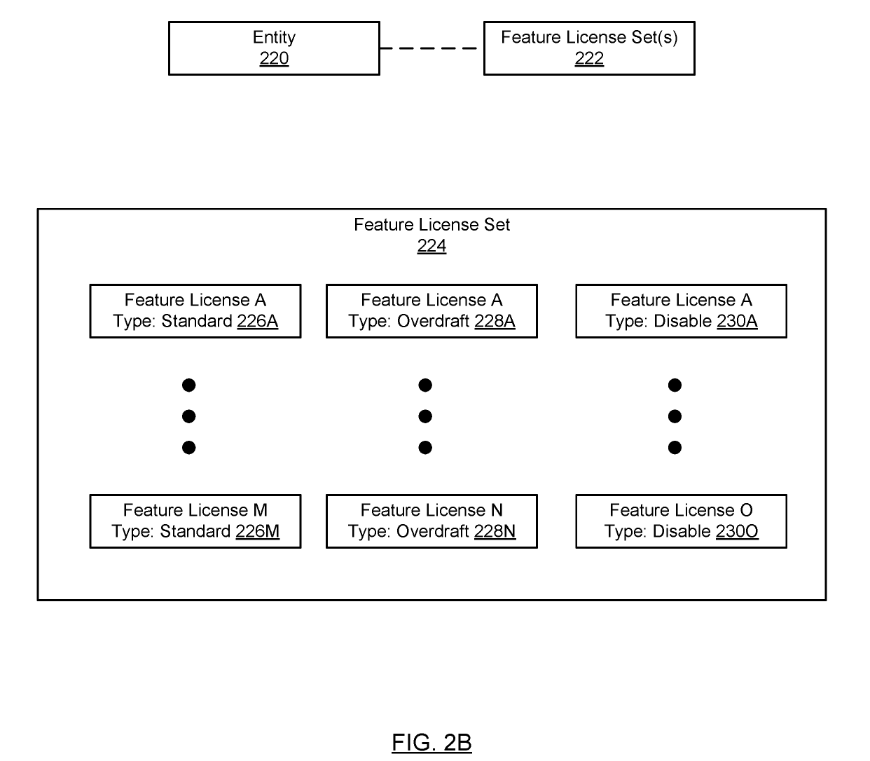

FIG. 2A shows a feature license in accordance with one or more embodiments of the invention. A feature license (200), in accordance with an embodiment of the invention, is a basic licensable unit. A feature license may be used, for example, to activate a particular hardware or software-based functionality. One or more attributes may be associated with a feature license. These attributes may include, but are not limited to a feature name (e.g. an alphanumeric descriptor) (204), a validity (206), a feature version (208) and a type (210).

The validity (206) may specify a time interval during which the feature is available under a feature license. The time interval may be specified using a license term beginning and/or a license term end. For example, an active feature license may be configured to be valid for a limited duration only, e.g., for ten hours. The license may thus require periodic renewal if it is to be used over a prolonged time or, alternatively, the licensee device may need to obtain a new feature license for the feature. The validity may also be device specific, for example, the validity may be limited to a particular group of hardware, a particular hardware device, a particular serial number, a particular media access control (MAC) address, etc. In one embodiment of the invention, the validity (206) of a given license may vary based on license type (discussed below). For example, a license with a license type of overdraft may have the same validity as a license of license type standard, while a license of license type disable may not have any expiration of its validity (i.e., it never expires). In another embodiment of the invention, a license of license type disable may have a validity that is the same as a license of license type standard. The various license types may have different validity periods without departing from the invention. Continuing with the discussion of FIG. 2A, the feature version (208) may specify what version (e.g. if there are different releases of different scope or date) is licensed.

The type (210) specifies the type of license. In one embodiment of the invention, there are three types of licenses—(i) standard, (ii) overdraft, and (iii) disable. Each of these license types is described below. A license type of standard corresponds to a license that an entity has purchased and that may be used to activate a corresponding feature on a network element. A license type of overdraft corresponds to license that was not purchased by the entity and that may be used to activate a corresponding feature on the network element. A license type of disable corresponds to a license that was not purchased by the entity; rather, this license type is issued to a licensee device when the entity (with which the licensee device is associated) has utilized all its standard licenses and overdraft licenses and/or when the entity has exceed some other threshold of overdraft licenses (e.g., the entity has used an excess number of overdraft licenses). Further, a license that has a license type of disable may not be used to activate a corresponding feature on the network element.

As discussed below with respect to FIG. 3, license types of overdraft and disable are generated by the central license manager for use by the licensee devices. As discussed in FIGS. 4 and 5 below, these two types of licenses are provided in response to license requests based on different criteria. Further, as discussed below, providing a license of type overdraft or a license of type disable to the network element triggers different behavior on the network element (e.g., a router, a switch, a multi-layer switch, etc.) and/or different types of behavior at the coordination point.

FIG. 2B shows relationships between various components in the system in accordance with one or more embodiments of the invention. More specifically, FIG. 2B shows the relationships between the entities and feature license set(s). As discussed above, each entity (220) may be purchase feature licenses from the licensor. The purchased feature licenses may also be referred to as feature licenses of license type standard. However, the central license manager may also generate (or obtain) overdraft and disable licenses for the entity, where these licenses are not purchased by the entity. The set of licenses for a given feature for a given entity may be referred to as feature license set (222) and may include one or more standard licenses (226A, 226M), one or more overdraft licenses (228A, 228N), and one or more disable licenses (230A, 230O). The specific number of each type of license that is part of the feature license set may vary based on, for example, feature usage data (discussed below) and/or default feature license type distribution (discussed below). Regardless of the absolute number of each type of license in a given feature license set, the total number of licenses in the feature license set is greater than or equal to the maximum number of possible of instances of a feature for which an entity may request a feature license. For example, if the entity is associated with five network elements and each of the network elements may implement a maximum of three instances of a feature, then the total number of feature licenses in the feature license set is at least 15.

In one embodiment of the invention, the number of overdraft licenses is greater than (i.e., a multiple of) the number of standard licenses. Further, the number of disable licenses is greater than the number of overdraft licenses and/or standard licenses. For example, if the feature license set requires 45 licenses and an entity has five standard licenses, then the central license manager may automatically generate 15 overdraft licenses (3× the number of standard licenses) and 25 disable licenses.

Those skilled in the art will appreciate that while FIGS. 1-2B describe three types of license types, embodiments of the invention may be implemented with more than three license types without departing from the invention.

FIGS. 3-5 show flowcharts in accordance with one or more embodiments of the invention. The flowcharts describe methods for license management and for automated distribution of feature licenses to licensee devices. Each of the flowcharts represents contributions of a particular component of the system for license management, as these components are interacting, in accordance with one or more embodiments of the invention. Prior to the execution of the methods described in FIGS. 3-5, a relationship between the licensor and the licensee may have been established. As a result, licensee information may be stored in the licensee database. This information may include credentials such as a licensee (or entity) name, e.g. the name of a company, or a user name, and a password, associated with the licensee name.

While the various steps in the flowcharts are presented and described sequentially, one of ordinary skill will appreciate that some or all of these steps may be executed in different orders, may be combined or omitted, and some or all of the steps may be executed in parallel. In one embodiment of the invention, the steps shown in FIGS. 3-5 may be performed in parallel with any other steps shown in FIGS. 3-5 without departing from the invention.

FIG. 3 shows steps of a method for license management performed by a central licensing manager.

In step 300, a request for standard licenses for the entity is received by the license manager. The request may be generated when the user purchases a set of standard licenses for a given feature or set of features. The request may be initiated from a computing system (see e.g., FIG. 6) operated by an entity. Alternatively, the request may be initiated by a user associated with the entity purchasing standard feature licenses via a web portal provided by the licensor. The web portal may be implemented using one or more computing systems as described in FIG. 6 below.

In one embodiment of the invention, prior to purchasing standard licenses, the entity may be provided with feature usage data (or data derived from feature usage data) (discussed below). For example, the entity may be provided with the following information on a per-feature basis: the number of standard licenses activated, the number of overdraft licenses activated, and the number of disable licenses activated. The aforementioned number may be based on feature usage data obtained over one or more time periods (e.g., feature usage data for the last 12 hours, feature usage data for the last week, etc.).

In one embodiment of the invention, the entity, as part of the request, may also indicate the number of overdraft and/or default licenses it would like to include in its feature license set. The aforementioned information may be used to determine/override the feature license type distribution (discussed below) that the central license manager generates for the feature license set. In another embodiment of the invention, the entity is not able to provide any requests related to non-standard license types.

Continuing with the discussion of FIG. 3, in step 302, the feature usage data for the entity is obtained. In one embodiment of the invention, the feature usage data specifies, on a per-feature basis, how a feature on a particular network element (which was activated using an overdraft license) is being used. For example, if the feature was activated with an overdraft license and then not used or used below some preset threshold, then the feature usage data may indicate that the feature was not used or lightly used. Similarly, if the feature was used above some preset threshold, then the feature usage data may indicate that the feature was heavily used. The feature usage data may also indicate the raw usage data of the feature (e.g., number of packets processed, etc.). The feature usage data may also specify, on a per-feature basis: the number of standard licenses activated, the number of overdraft licenses activated, and the number of disable licenses activated. The aforementioned number may be based on feature usage data obtained over one or more time periods (e.g., feature usage data for the last 12 hours, feature usage data for the last week, etc.). The feature usage data may include additional and/or different information without departing from the invention.

In step 304, the feature license type distribution is determined. The feature license type distribution specifies how many license of each license type should be included in the license feature set for the feature. In one embodiment of the invention, the feature license type distribution is determined using default setting when there is no (or very limited) feature usage data. In another embodiment of the invention, the feature license type distribution is determined based on information about the feature license type distribution included in the request (i.e., the request in step 300).

In another embodiment of the invention, the feature license type distribution is determined based on the feature license information about the feature usage data. For example, consider a scenario in which a first feature license set is generated that includes 100 feature licenses with the following feature license type distribution: 20 standard licenses, 40 overdraft licenses and 40 disable licenses. Further, the entity (across its various network elements) has used 20 standard licensees and 38 overdraft licenses. Based on this feature usage data, the central licensing manager may change the feature license type distribution in a second feature license set to: 20 standard licenses, 30 overdraft licenses and 50 disable licenses. By changing the feature license type distribution, the licensor may trigger the licensee (i.e., the entity) to obtain more standard licenses. In another embodiment of the invention, if an entity has consistently used an excessive amount of overdraft licenses (e.g., the entity has been using 50% of the overdraft licenses for at least a week), then the central licensing manager may set the feature license type distribution to include more disable licenses than overdraft licenses. Other heuristics for modifying the feature license type distribution may be implemented without departing from the invention.

In step 306, feature licenses of the various feature license types are activated based on the feature license type distribution determined in step 304. In step 308, the feature license set is then provided to the coordination point.

FIG. 4 shows steps of a method for license management, performed by the coordination point.

In step 400, a license request is received from a licensee device. The license request may specify information about the feature and information about the network element that requested the feature (e.g., an identifier of the network element (such as a MAC address), the name of the entity (i.e., the licensee) with which the network element is associated, etc.). The license request may include additional and/or different information without departing from the invention.

In step 402, a determination is made about whether there is a standard license (i.e., a feature license of license type standard) available. The determination in step 402 may include using some or all of the information in the license request in order to identify: (i) an appropriate feature license set (i.e., a feature license set associated with the entity that includes feature licenses for the feature specified in the license request) and (ii) determining whether there are any non-allocated standard licenses available to provide to the licensee device. If there is at least one non-allocated standard license available, then the process proceeds to step 404; otherwise, the process proceeds to step 406.

In step 404, a standard license from the set of non-allocated standard licenses is selected and the local license server records are updated to reflect that the selected standard license has now been allocated. The local license server records may also track information such as when the standard license was allocated and to which specific licensee device that standard license was allocated. The process then proceeds to step 412.

In step 406, a determination is made about whether there is an overdraft license (i.e., a feature license of license type overdraft) available. The determination is step 406 may include using some or all of the information in the license request in order to identify: (i) an appropriate feature license set (i.e., a feature license set associated with the entity that includes feature licenses for the feature specified in the license request) and (ii) determining whether there are any non-allocated overdraft licenses available to provide to the licensee device. If there is at least one non-allocated overdraft license available, then the process proceeds to step 408; otherwise, the process proceeds to step 410.

In step 408, an overdraft license from the set of non-allocated overdraft licenses is selected and the local license server records are updated to reflect that the selected overdraft license has now been allocated. The local license server records may also track information such as when the overdraft license was allocated and to which specific licensee device the overdraft license was allocated. The process then proceeds to step 412. Though not shown in FIG. 4, the coordination point may issue a notification to the central license manager when an overdraft license has been allocated for a particular feature to a particular licensee device for a given entity. In this manner, the central licensing manager may receive immediate (or substantially immediate) feedback about when overdraft licenses are allocated. In response to receiving such a notification, the central licensing manager (or another computing system operatively connected to the central licensing manager) may issue a notification (e.g., in the form of an email or text message) to the user (such as an network administrator for the entity) indicating that an overdraft license was issued and that additional standard licenses may need to be purchased.

In step 410, a non-allocated disable license from the license feature set is selected and the local license server records are updated to reflect that the selected disable license has now been allocated. The local license server records may also track information such as when the disable license was allocated and to which specific licensee device the disable license was allocated. The process then proceeds to step 412.

In one embodiment of the invention, step 410 may also include issuing a notification to the central license manager that a disable license has been allocated for a particular feature to a particular licensee device for a given entity. In this manner, the central licensing manager may receive immediate (or substantially immediate) feedback about when disable licenses are allocated. In response to receiving such a notification, the central licensing manager (or another computing system operatively connected to the central licensing manager) may issue a notification (e.g., in the form of an email or text message) to the user (such as an network administrator for the entity) indicating that a disable license was issued and that additional standard licenses may need to be purchased.

Continuing with the discussion of FIG. 4, in step 412, the selected license (i.e., the license selected in step 404, 408, or 410) is transmitted to the licensee device which sent the license request in step 400.

In one embodiment of the invention, the number of licenses in a given feature license set for a given feature is sized such that the result of performing the method shown in FIG. 4 always results in a feature license (which may be of any license type that was not previously allocated) being provided to the licensee device. In such embodiments, there is not a scenario in which the license request is denied.

Those skilled in the art will appreciate the license type selection method shown in FIG. 4 may be performed by the licensee device instead of the coordination point. In such cases, the licensee device may issue specific requests for various types of licenses until the coordination point ultimately returns a license to the licensee device.

FIG. 5 shows steps of a method for license management, performed by the licensee device.

In step 500, a determination is made that a feature license is required by the licensee device. A feature license may be required because a feature requiring the feature license is not activated, and the local license client of the licensee device is unable to provide the license, for example, because it is not in possession of the required license. The feature that requires a feature license may be a software and/or hardware-based feature.

Alternatively, the feature may be an already activated feature for which a license renewal is necessary because the current feature license is about to expire. For example, the licensee device may already have a feature license type of standard or overdraft, where the feature license is about to expire. In such instances, the licensee device, prior to expiration of the feature license, issues a license request to the coordination point. In another example, the licensee device may already have a feature license type of disable. In such instances, the licensee device may periodically (e.g., every hour) issue a license request to the coordination point for a feature license in an attempt to obtain a standard license or an overdraft license.

Continuing with the discussion of FIG. 5, in step 502, the licensee device issues a license request to the coordination point for a feature license for a feature (as determined in Step 500).

In step 504, a feature license is received from the local license server of the coordination point. The feature license may be delivered as a binary file that may include license attributes such as the validity (e.g., specifying an expiration date) and other limitations. In one embodiment of the invention, the feature license, provided by the local license server, is delivered to the local license client of the coordination point. The file used to deliver the feature license may be cryptographically protected (e.g. using a private/public key pair) such that only the local license server can access the license. Further, the file may be digitally signed to prevent tampering with feature license.

In step 506, the feature license is stored in the trusted storage of the licensee device.

In step 508, the license type of the feature license obtained in step 504 is determined. If the license type is disable, then the feature is not activated and the process end; otherwise, the process proceeds to step 501. As discussed above, in some embodiments of the invention, receiving a disable license may trigger the licensee device to periodically issue a license request for a feature license in order for the licensee device to obtain a non-disable license (e.g., a standard license or an overdraft license). In one embodiment of the invention, if the feature is currently associated with a standard or overdraft license and then the licensee device subsequently obtains a disable license for the feature (via step 504), then the feature may be deactivated.

Continuing with the discussion of FIG. 5, in step 510, the local license client, having received the feature license, allows activation of the feature for which the feature license was requested in Step 502.

In step 512, a determination is made about whether the license type of the feature license obtained in step 504 is overdraft. If the license type is not overdraft, then the process ends. Otherwise, the process proceeds to step 514. In step 514, the licensee device initiates collection of feature usage data (described above) and periodically provides this feature usage data directly to the licensor side (see e.g., FIG. 1, 120) or indirectly to the licensor side via the coordination point.

Example Use Case

The use case scenario described below is intended to provide an example of the method for license management, described in FIGS. 3-5, and is for illustrative purposes only. The use case scenario is based on a system similar to the one shown in FIG. 1, where the licensee devices (102A-102N) are network elements such as routers, switches and/or multilayer switches. The functionalities to be licensed are network element functionalities that include enhanced layer 3 functionalities (e.g., the border gateway protocol (BGP)), virtualization (e.g., to support Virtual Extensible LAN (VXLAN)), monitoring and provisioning tools, etc. The method described by FIGS. 3-5 is limited to neither the system shown in FIG. 1, nor to the use case scenario described below, but rather is universally applicable to a wide range of systems of different configuration, complexity and size.

Consider a scenario in which a coordination point has received, from the central license manager, feature license set (FLS) 1, which includes three standard licenses, four overdraft licenses, and three disable licenses. Further, assume that the standard and overdraft licenses are valid for 12 hours and the disable licenses never expire. In this scenario, all three standard licenses and all four overdraft licenses are allocated to various network elements. After this occurs, the network elements that includes features that were activated using the overdraft licenses periodically send feature usage data to the central licensing manager (via the coordination point).

At some later point in time, the coordination point receives a license request for the feature and, in accordance with FIG. 5, allocates and sends a disable license to the requesting network element. As a result of allocating the disable license, the central license manager is notified that a disable license for a feature has been allocated. In response to this notification, the central licensing manager issues an email to the network administrator for the entity associated with the network element that received the disable license. In response to the email, the network administrator purchases an additional standard license. The central licensing manager subsequently adds this standard license to FLS 1. At some later point in time, coordination point receives a license request from the network element that had previously received the disable license and, in response to this request, provides the standard license to the coordination point.

In this use case scenario assume that the central license manager issues new licenses every 12 hours. Accordingly, the central license manager uses the feature usage data (previously obtained) in order to determine a new feature license type distribution. In this example, the new feature license type distribution includes four standard licenses, four overdraft licenses, and two disable licenses. The central license manager generates FLS 2 based on the new feature license type distribution and subsequently sends FLS 2 to the coordination point.

At some point after FLS 2 has been received by the coordination point and prior to the expiration of the previously allocated feature licenses, the network elements that have feature licenses allocated from FLS 1 perform the method shown in FIG. 5 in order to obtain new feature licenses.

Embodiments of the invention provide a mechanism through which network elements may activate features even though they have not proactively purchased standard licenses. This allows network elements to rapidly activate features and then subsequently obtain standard licenses. In addition, the telemetry provided by feature usage data obtained from network elements that activate features using overdraft licenses and notifications provided when disable licenses are allocated provide the central licensing manager and the licensees greater visibility into which features are being used and how these features are being used.

Embodiments of the invention may be implemented on a computing system. Any combination of mobile, desktop, server, embedded, or other types of hardware may be used. For example, as shown in FIG. 6, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for license management, the method comprising:
receiving a first license request for a feature from a network element;
in response to the first license request:
making a first determination that no feature licenses of a first type are available for the feature;
based on the first determination, making a second determination that a feature license of a second type is available for the feature; and
providing the feature license of the second type to the network element.

2. The method of claim 1, further comprising receiving a second license request for the feature from a second network element;
in response to the second license request:
making a third determination that no feature licenses of the first type are available for the feature and that no feature licenses of the second type are available for the feature; and
based on the third determination providing a feature license of a third license type to the second network element.

3. The method of claim 2, wherein the first license type is standard, the second license type is overdraft, and the third license type is disable.

4. The method of claim 2, further comprising:
after providing the feature license of the third license type to the second network element:
notifying the central licensing manager that the second network element was provided with the feature license of the third license type.

5. The method of claim 2, wherein licenses of the first license type, licenses of the second license type, and licenses of the third license type are associated with a first feature license set for an entity, and wherein the first feature license set has a first license type distribution.

6. The method of claim 5, further comprising:
receiving a second feature license set for the entity from a central license manager, wherein the second feature license set has a second license type distribution, second license type distribution is different than the first license type distribution.

7. The method of claim 1, further comprising:
after providing the feature license of the second license type to the first network element:
receiving, from the first network element, feature usage data for the feature; and
providing the feature usage data to a central licensing manager.

8. The method of claim 1, wherein the first license type is standard and the second license type is overdraft.

9. The method of claim 1, further comprising:
after providing the feature license of the second license type to the first network element:
notifying the central licensing manager that the first network element was provided with the feature license of the second license type.

10. The method of claim 1, wherein licenses of the first license type and licenses of the second license type are associated with a first feature license set.

11. A method for license management comprising:
sending, from a network element, a first license request for a first feature to a license server;
receiving, in response the first license request, a first feature license of a first license type;
activating the first feature on the network element using the first feature license of the first license type,
in response to activating the first feature on the network element, collecting feature usage data for the first feature;
providing the feature usage data to the license server;
sending a second license request for a second feature to the license server;
receiving, in response the second license request, a second feature license of a second license type;
in response to receiving the second feature license of the second license type:
periodically sending license requests to the license server to obtain one selected from a group consisting of a third feature license of the first license type and a fourth feature license of a third license type,
wherein the second feature is not activated in response to receiving the second feature license of the second license type.

12. The method of claim 11, wherein the first license type is overdraft, the second license type is disable, and the third license type is standard.

13. The method of claim 11, wherein the network element is one selected from a group consisting of a router, a switch, and a multi-layer switch.

14. A method for license management comprising:
receiving feature usage data associated with a plurality of network elements using a feature;
determining, using the feature usage data, a feature license type distribution for the feature;
generating, based on the feature license type distribution, a feature license set comprising a plurality of feature licenses, wherein the feature license set comprises at least one feature license of a first license type and at least one feature license of a second license type; and
providing the feature license set to a local license server.

15. The method of claim 14, wherein a cardinality of feature licenses of the first license type is less than a cardinality of feature licenses of the second license type.

16. The method of claim 14, wherein the feature license set further comprises at least one feature license of a third license type

17. The method of claim 16, wherein a cardinality of feature licenses of the second license type is less than a cardinality of feature licenses of the third license type.

18. The method of claim 17, wherein the first license type is standard, the second license type is overdraft, and the third license type is disable.

19. A system for license management, comprising:
a coordination point operatively connected to plurality of network elements, wherein the coordination point is configured to:
receive a license request for a feature from a network element of the plurality of network elements;
in response to the license request:
make a first determination that no feature licenses of a first type are available for the feature;
based on the first determination, make a second determination that a feature license of a second type is available for the feature; and
provide the feature license of the second type to the network element;
after providing the feature license of the second license type to the first network element:
receive, from the first network element, feature usage data for the feature; and
provide the feature usage data to a central licensing manager.

20. The system of claim 19, further comprising:
the central license manager operatively connected to the coordination point, wherein the central license manager is configured:
receive the feature usage data associated;
determine, using the feature usage data, a feature license type distribution for the feature;
generate, based on the feature license type distribution, a feature license set comprising a plurality of feature licenses, wherein the feature license set comprises at least one feature license of a first license type and at least one feature license of a second license type; and
provide the feature license set to the coordination point;
wherein the coordination point is further configured to:
service a second license request for the feature from a second network element of the plurality of network elements using the feature license set.
